(19) United States
(12) Patent Application Publication
(10) Pub. No.: US 2013/0199564 A1
(43) Pub. Date: Aug. 8, 2013

(54) Retractable Display Screen Cleaner

(71) Applicants: Michelle L. HYERS, Greenlawn, NY (US); Breanna STACHOWSKI, Elma, NY (US)

(72) Inventors: Michelle L. HYERS, Greenlawn, NY (US); Breanna STACHOWSKI, Elma, NY (US)

(21) Appl. No.: 13/368,907

(22) Filed: Feb. 8, 2012

(51) Int. Cl. A47L 13/17; B08B 1/04

(52) U.S. Cl. 134/6; 15/104.94

(57) ABSTRACT

A hand held cleaning apparatus with a retractable, self-replenishing cleaning assembly used to remove fingerprints and dirt from display screens. A dry compound is used to clean screens ranging from personal cell phone screens to larger monitor-sized display screens. In a simple one-handed motion, the cleaning assembly is extended to be used, and then retracted for storage.

### FIELD OF THE INVENTION

The present invention relates to screen cleaners and more particularly retractable screen cleaners utilizing dry cleaning compounds to effectively and efficiently remove fingerprints and other debris from the screens of cellular phones, tablets, monitors, and other display screens.

Display screens are in constant use by individuals whether on cellular phones, computer monitors, or computer tablets, and are often touch screens that require the user to place his or her fingers on the screen surface. This often leaves residue such as fingerprints and other debris behind on the surface of the screen, and can sometimes etch into the glass surface of the screen if left unclean for too long, causing a permanent imperfection. Screen cleaners provide a way for removing many types of grime and debris from the surface of the screen.

### BACKGROUND OF THE INVENTION

Many screen cleaners are available on the market today. Among them, most are bulky and require two parts, or two hands to use. One problem with prior art is the inability to store a compact, dry cleaner in a pocket or carrying case without the worry of spilling liquid. Much of the prior art, including the SideKick and Laptop Pro, have large, bulky profiles, and must be used with two hands. This is not only inconvenient for a user on the go, but makes it difficult to store the item inconspicuously. For example, the SideKick and Laptop Pro are more than 15 mm in thickness, making them obtrusive in ones pocket and carrying case. Furthermore, both of the aforementioned cleaners have caps that must be removed before the apparatus could be used. After reviewing the prior art, what is needed is a retractable display screen cleaner which utilizes a switch mechanism that allows the user to extend and retract the cleaning assembly easily and efficiently with one hand. This would also make replenishing the cleaning pad easily one handed as well, whereas prior art forced the user to replenish the cleaning pad by removing or attaching a cap with two hands. This can be extremely inconvenient in many situations. For example, if one needed to clean his or her display screen while engaged in another activity (walking, giving a presentation, or combat for example) they would have to (1) put down said display screen, (2) remove the cap with both hands, (3) safely secure the cap in another location, (4) pick up said display screen, (5) clean said screen, (6) put down said screen again, (7) find the cap for the cleaner, (8) replace said cap with both hands, and (9) retrieve said display screen. In response to prior art, a cleaning apparatus is needed that allows one to simply (1) slide out the cleaning assembly via switch and linear track, (2) clean said display screen, and (3) retract said cleaning assembly, all while maintaining a grip on said display screen. This presents a much quicker, cleaner, and effective manner of cleaning a display screen.

Another problem with prior art is that liquid cleaning agents that frequently include solvents and other liquid cleaning agents. Frequently, these are sold as kits, and include the liquid cleaning agent and a cleaning cloth or tissue, or, a cleaning cloth infused with a cleaning agent. There are several issues with these types of cleaners: the first issue is that often times the solvents utilized in liquid cleaners can remove protective coatings from the screen. This can include anti-reflective coatings, and oleophobic coatings that repel fingerprints. A second problem is the limited lifespan of the wet cleaning agent. When infused with a wet cleaning agent, a cleaning tissue can only be used until the agent has dried, and then must be thrown out. This presents a wasteful solution to cleaning screens. A third problem is the abrasiveness of the paper of which many screen cleaning tissues are made.

An advantage of the present invention is the ability to retract the cleaning assembly and carry the apparatus inconspicuously in a pocket or carrying case due to its dry nature and slim profile.

An objective of the present invention is to improve upon the utilization of prior arts' need for two hands while opening, using, and closing the cleaning apparatus.

Another objective of the present invention is to improve upon the limited lifespan of wet cleaning agents. Said screen cleaner utilizes a dry cleaning compound that is long-lasting and self-replenishing.

Still another advantage of the present invention is the use of a soft, natural cleaning pad that will not scratch or otherwise affect the finish of the screen.

A final objective of the present invention is to provide an improved screen cleaner that will have no harm on a screen's surface or coatings. Said screen cleaner utilizes a solvent-free, organic compound that is harmless to coatings such as anti-reflective coatings and oleophobic coatings.

Any additional objectives and advantages of this invention will become more apparent from a consideration of the drawings and ensuing description.

Thus, a screen cleaner that is slim and can be used with one hand, non-abrasive and long-lasting, while causing no damage to the surface coatings of the screen, as well as being designed in a way that is efficient in profile and utility, would provide distinct and desirable advantages over the prior art. It is thus believed that the present invention overcomes the aforementioned deficiencies and achieves the aforementioned and below mentioned objectives.

### SUMMARY OF THE INVENTION

In order to overcome the perceived deficiencies in the prior art and to achieve the objectives and advantages set forth above and below, the present invention is, generally speaking, directed to a novel and improved screen cleaner, which utilizes a retractable dry-cleaning assembly which can be reused and stored in small spaces such as a pocket or briefcase. Also provided herein are methods of using the cleaner on various screens.

The invention accordingly comprises the features of construction, combination of elements, and arrangement of parts which will be exemplified in the construction, illustration, and description hereinafter set forth, and the scope of the invention will be indicated in the claims.

In a preferred embodiment, the screen cleaner comprises: a handheld cleaning apparatus for a display screen, comprising: a main body, the main body comprising a cavity; a cleaning assembly coupled to the main body, wherein the cleaning assembly comprises a pad having a cleaning compound thereon for wiping upon the surface of a display screen, wherein the cleaning assembly is retractable into the cavity and extendable out of the cavity; and an extending/retracting member, coupled to the cleaning assembly and slideably mounted to the main body, for facilitating the retracting of the cleaning assembly into the cavity and extending the cleaning assembly at least partially out of the cavity.

In another preferred embodiment, main body of the cleaning apparatus is of an appropriate shape and size to be held, extended, employed in cleaning a display screen, and retracted, while maintaining a one-handed grip on the cleaning apparatus. Likewise, the cleaning compound is comprised of a dry cleaning agent including carbon black, wherein the soft pad is made of a chamois material, and includes a track for guiding the extending/retracting member along the main body. Furthermore, a preferred embodiment is designed such that the cleaning assembly is coupled to the extending/retracting member via a hinge and spring mechanism, wherein the extending/retracting member is a switch, and the cleaning assembly when extended out of the cavity, is rotatable relative to the main body.

A further preferred embodiment suggests that the cleaning assembly is comprised of a secondary foam pad and a rigid backing plate, wherein a secondary pad is adhered in between the soft cleaning pad and the rigid backing plate, and the cleaning assembly when extended is snap-fittable into the main body via male and female connectors.

An additional preferred embodiment would include a replenishment pad on which there is cleaning compound material, wherein the cleaning compound on the soft cleaning pad is replenished by at least one of the retraction or extension of the cleaning assembly from the main body, wherein said replenishment pad is constructed of an absorbent substance, and a portion of the replenishment pad and cleaning assembly is covered by a hinged flap that opens for extension and closes upon retraction of said cleaning assembly.

A preferred method of using a handheld cleaning apparatus for a display screen, wherein the apparatus comprises a main body, the main body comprising a cavity; a cleaning assembly coupled to the main body, wherein the cleaning assembly comprises a pad having a cleaning compound thereon for wiping upon the surface of a display screen, wherein the cleaning assembly is retractable into the cavity and extendable out of the cavity; and an extending/retracting member, coupled to the cleaning assembly and slideably mounted to the main body, for facilitating the retracting of the cleaning assembly into the cavity and extending the cleaning assembly at least partially out of the cavity, wherein the method comprises the steps of: grasping the cleaning apparatus in a first hand; while maintaining a grip on the cleaning apparatus with the first hand, sliding the extending/retracting member with the thumb of the first hand to extend the cleaning assembly from the cavity; contacting the pad of the cleaning assembly with a display screen; applying pressure to the pad and wiping the display screen with the pad of the cleaning assembly; and retracting the cleaning assembly into the cavity.

The method of the above preferred embodiment also ensures in another preferred embodiment the automatic replenishment of said pad with said cleaning compound housed in the replenishment pad with the extension and retraction of said cleaning assembly.

### BRIEF DESCRIPTION OF THE DRAWINGS

The above set forth and other features of the invention are made more apparent in the ensuing Description of the Preferred Embodiment when read in conjunction with the attached drawings, wherein:

FIG. 1 is a perspective view of the preferred embodiment of the display screen cleaner showing the extended cleaning assembly and rigid backing plate from the top.

FIG. 2 is a perspective view of the preferred embodiment of the display screen cleaner showing the cleaning assembly retracted into the main body.

FIG. 3 is a perspective view of the preferred embodiment of the display screen cleaner showing the optional hinged flap enclosing the cleaning assembly and replenishment pad when retracted.

FIG. 4 is a perspective view of the preferred embodiment of the display screen cleaner showing the extended cleaning assembly and rigid backing plate from the top, and includes optional thumb or finger grooves.

FIG. 5 is a perspective view of the preferred embodiment of the display screen cleaner showing the extended cleaning assembly and rigid backing plate from the top, and includes optional thumb or finger grooves, as well as an optional keychain or clip retaining mechanism.

FIG. 6 is an isometric view of the preferred embodiment of the display screen cleaner showing the main body from the left while the cleaning assembly is retracted, as well as the male connectors.

FIG. 7 is an isometric view of the preferred embodiment of the display screen cleaner showing the main body from the front while the cleaning assembly is extended, as well as the spring and hinge mechanism connecting the cleaning assembly to the switch.

FIG. 8 is a perspective view of the preferred embodiment of the display screen cleaner showing the cleaning assembly retracted into the main body, whereas the main body consists of ergonomic cutouts and male connectors.

FIG. 9 is an isometric view of the preferred embodiment of the display screen cleaner showing the main body from the left while the cleaning assembly is extended, as well as the male connectors locked into the female connectors of the cleaning assembly.

FIG. 10 is a perspective view of the preferred embodiment of the display screen cleaner showing the extended cleaning assembly and rigid backing plate from the top, and includes two optional thumb or finger grooves.

FIG. 11 is a section view of the preferred embodiment of the display screen cleaner showing the inner replenishment pad.

FIG. 12 is a perspective view of the preferred embodiment of the display screen cleaner showing the one-handed grip with the user's thumb on the switch.

FIG. 13 is a perspective view of the preferred embodiment of the display screen cleaner showing the one-handed extension of the cleaning assembly with the user's thumb pushing the switch.

FIG. 14 is a perspective view of the preferred embodiment of the display screen cleaner showing the one-handed use of the cleaning apparatus with the user's thumb applying pressure to the rigid backing plate of the cleaning assembly.

Identical reference numerals in the figures are intended to indicate like parts, although not every feature in every figure may be called out with a reference numeral.

### DESCRIPTION OF THE PREFERRED EMBODIMENTS

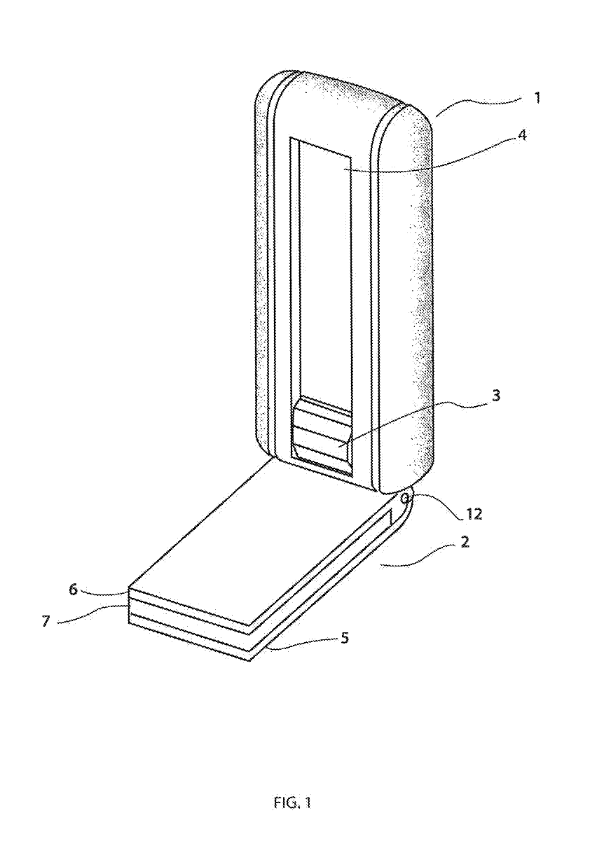

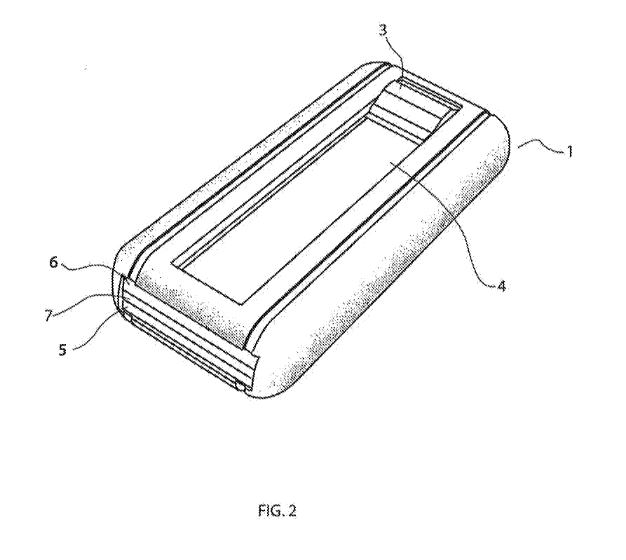

The invention shows a retractable display screen cleaning apparatus in FIG. 1 in the extended cleaning state, wherein a cleaning assembly 2 is attached to the main body 1 via a switch 3 and track 4. Said cleaning assembly is composed of at least a soft pad 5 containing a cleaning compound. Other components of said cleaning assembly may include a rigid backing plate 6 and a secondary pad 7 between said soft cleaning pad 5 and said rigid backing plate 6. By using one's thumb or finger, said cleaning assembly 2 may be one-handedly extended via switch 3 and track 4 into the cleaning position, and retracted in the same manner into the storage position, as in FIG. 2. While in said storage position, it is noted that the switch 3 has been pushed or pulled to the back of the track 4, thereby retracting said cleaning assembly 2 into the main body 1 of the device.

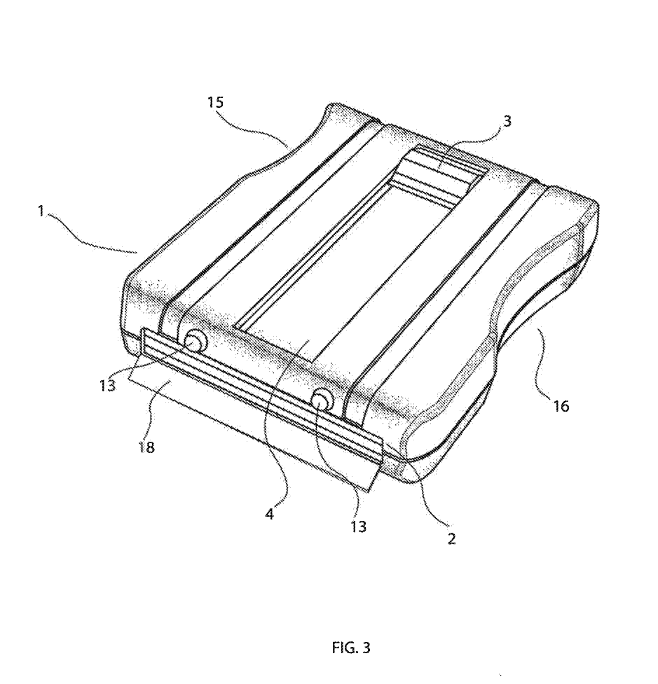

The retractable display screen cleaner as shown in FIG. 3 contains a hinged flap 18 that can open or close during extension or retraction of said cleaning assembly 2 in order to cover the cleaning assembly 2 when not in use.

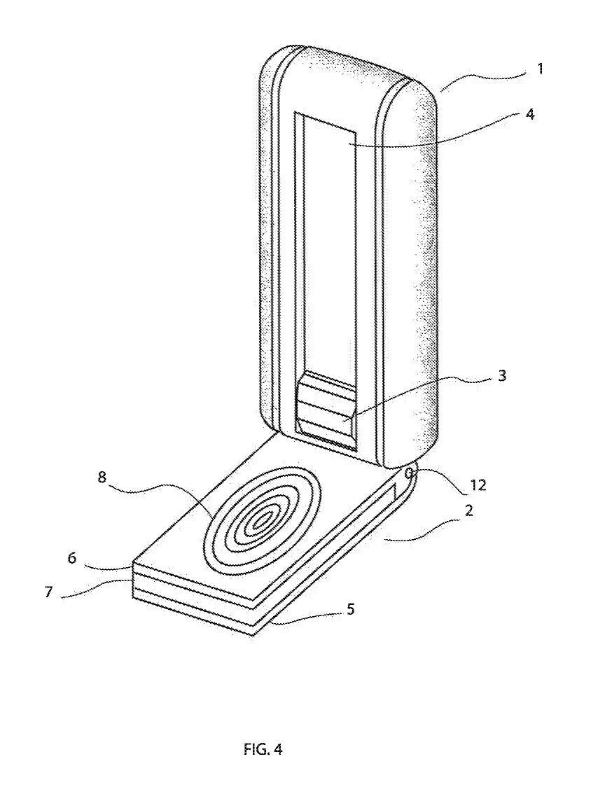

The retractable display screen cleaner is shown in another preferred embodiment in FIG. 4, having optional thumb or finger grooves 8 in order to assist with the placement of one's fingers during cleaning. While there are multiple configurations that may be used with said cleaning apparatus, placing one's thumb or fingers directly onto the rigid backing plate 6c allows even distribution of pressure along the soft cleaning pad 5c and display screen.

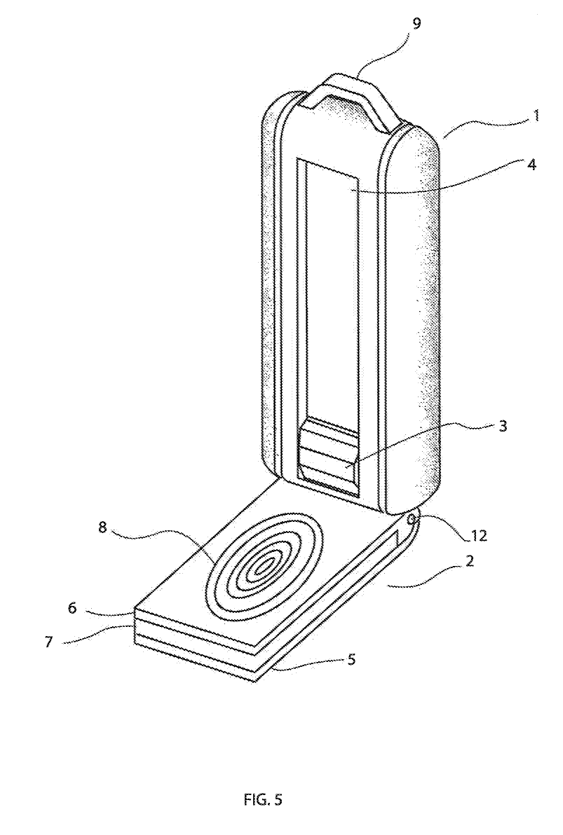

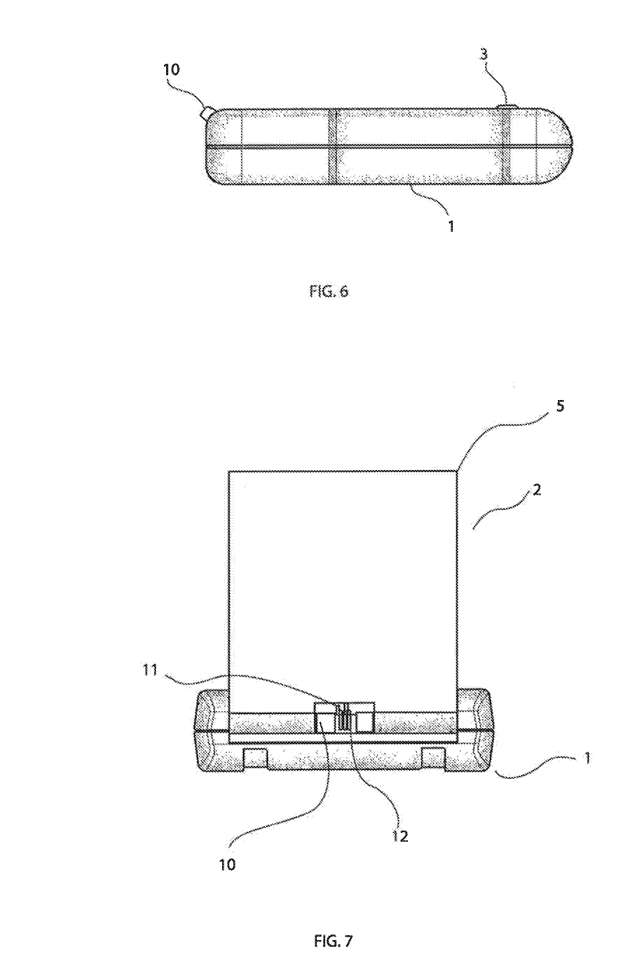

As can be seen in FIG. 5, another preferred embodiment of said retractable display screen cleaner includes an optional keychain or clip attachment mechanism 9. The slim profile of said cleaner as seen in FIG. 6 allows for the cleaning apparatus to be hung from a keychain or other clip while being lightweight and remaining inconspicuous.

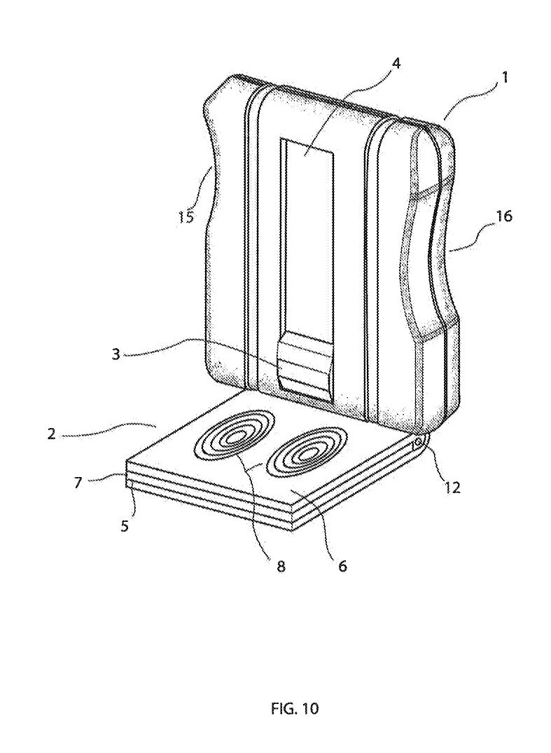

The preferred embodiment of the invention features a cleaning assembly 2 such as that in FIG. 7 and FIG. 9 that automatically orients itself into the appropriate cleaning position via a hinge 10 and spring 11 mechanism around an offset axis 12 when being extended, and likewise automatically orients itself into a storage position when retracted.

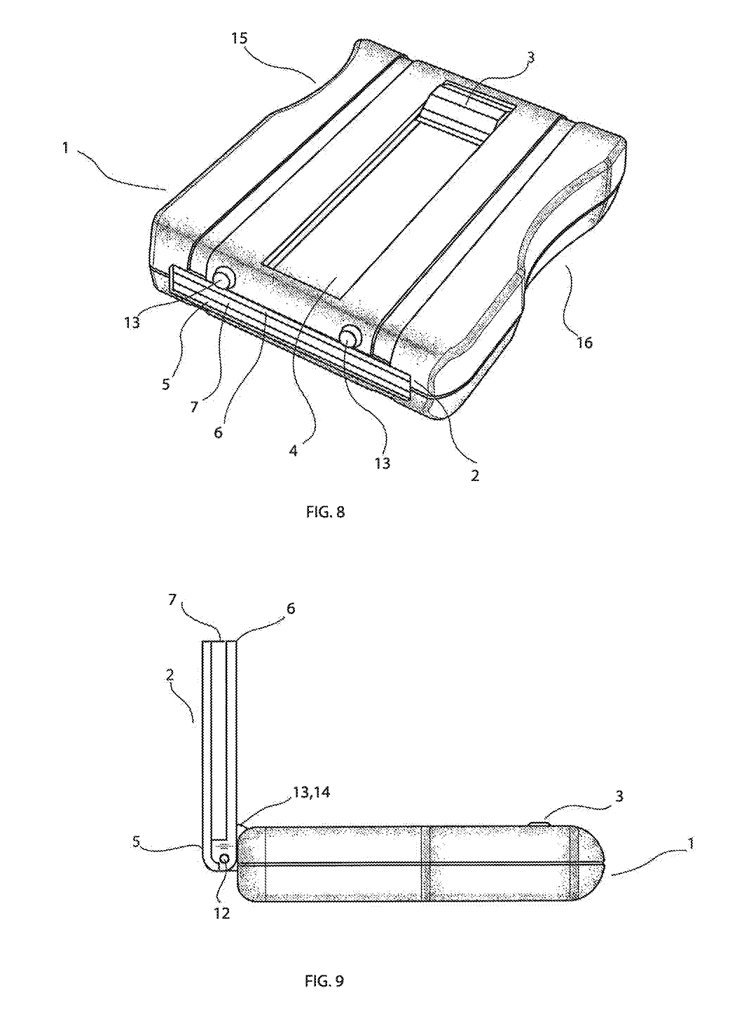

In another preferred embodiment, said cleaning assembly 2 may be snapped into the main body 1 by utilizing male 13 and female 14 connectors, such as those seen in FIG. 8 and FIG. 9. Male 13 and or female 14 connectors on the main body 1 will snap fit into opposing connectors on the cleaning assembly 2. As seen in FIG. 10, when the cleaning assembly 2 is snapped into the main body 1, the user can apply pressure from the top of the main body 1 using integrated ergonomic cutouts in the body 15 and 16. These cutouts 15 and 16 allow the user to comfortably grasp the main body 1 and utilize the cleaning apparatus in one of its multiple, one-handed orientations.

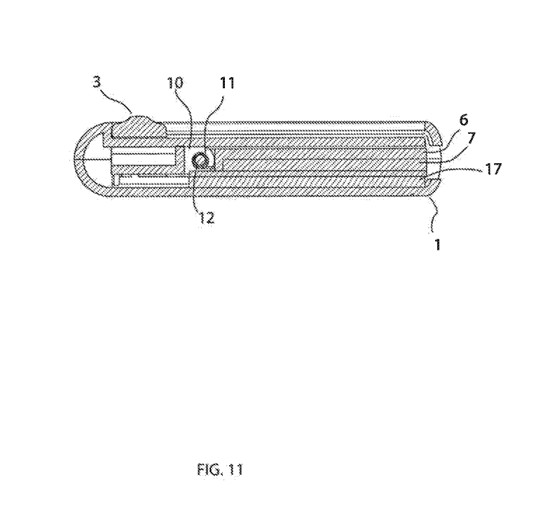

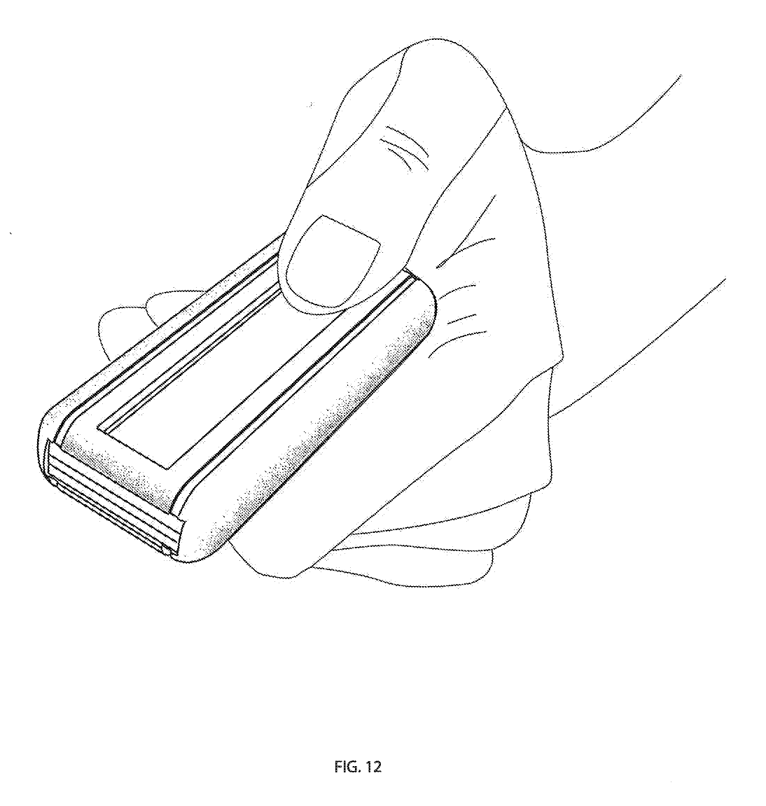

The display screen cleaning apparatus in its preferred embodiment also integrates a self replenishing mechanism 17 that is stored within the main body 1 as seen in FIG. 11. Upon extending and retracting the cleaning assembly 2, said soft cleaning pad 5 automatically is replenished via the internal reservoir 17.

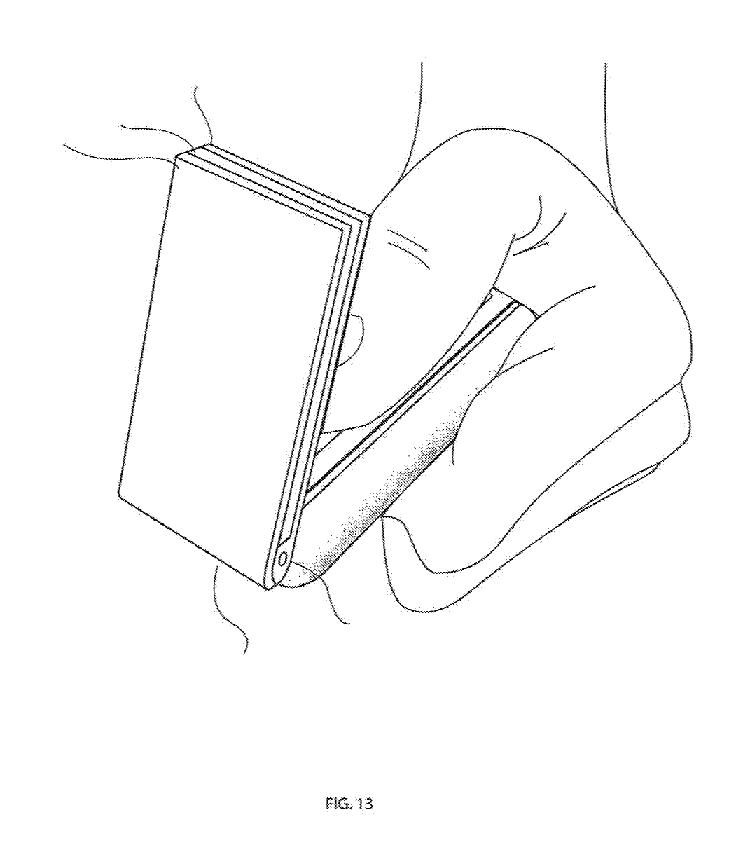

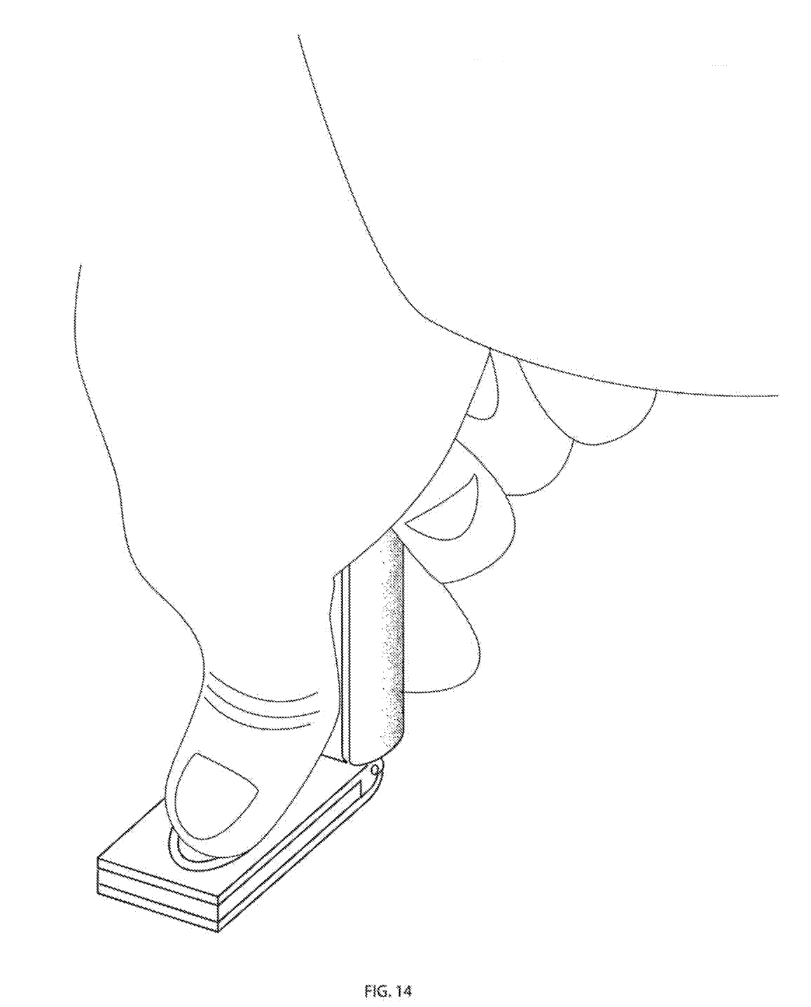

In a preferred embodiment of use, the display screen cleaner is showed in FIG. 12, FIG. 13, and FIG. 14 as being held, extended, and used while maintaining a one-handed grip on said cleaning apparatus.

It can thus be seen that the present invention is advantageous and overcomes the perceived deficiencies in the prior art.

It will thus be seen that the objects set forth above, among those made apparent from the preceding description, are efficiently attained and, since certain changes may be made in the above constructions without departing from the spirit and scope of the invention, it is intended that all matter contained in the above description or shown in the accompanying drawings shall be interpreted as illustrative and not in a limiting sense.

It should also be understood that the following claims are intended to cover all of the generic and specific features of the invention described herein and all statements of the scope of the invention that as a matter of language might fall there between.

What is claimed is:

1. A handheld cleaning apparatus for a display screen, comprising:
a main body, the main body comprising a cavity;
a cleaning assembly coupled to the main body, wherein the cleaning assembly comprises a pad having a cleaning compound thereon for wiping upon the surface of a display screen, wherein the cleaning assembly is retractable into the cavity and extendable out of the cavity; and
an extending/retracting member, coupled to the cleaning assembly and slideably mounted to the main body, for facilitating the retracting of the cleaning assembly into the cavity and extending the cleaning assembly at least partially out of the cavity.

2. The cleaning apparatus of claim 1, wherein the main body is of an appropriate shape and size to be held, extended, employed in cleaning a display screen, and retracted, while maintaining a one-handed grip on the cleaning apparatus.

3. The cleaning apparatus as claimed in claim 1, wherein the cleaning compound is comprised of a dry cleaning agent including carbon black.

4. The cleaning apparatus of claim 1, wherein the soft pad is made of a chamois material.

5. The cleaning apparatus as claimed in claim 1, including a track for guiding the extending/retracting member along the main body.

6. The cleaning apparatus as claimed in claim 1, wherein the cleaning assembly is coupled to the extending/retracting member via a hinge and spring mechanism.

7. The cleaning apparatus as claimed in claim 1, wherein the extending/retracting member is a switch.

8. The cleaning apparatus as claimed in claim 1, wherein the cleaning assembly when extended out of the cavity, is rotatable relative to the main body.

9. The cleaning apparatus as claimed in claim 1, comprising a secondary foam pad and a rigid backing plate.

10. The cleaning apparatus as claimed in claim 8, wherein a secondary pad is adhered in between the soft cleaning pad and the rigid backing plate.

11. The cleaning apparatus as claimed in claim 1, wherein the cleaning assembly when extended is snap-fittable into the main body via male and female connectors.

12. The cleaning apparatus of claim 1, including a replenishment pad on which there is cleaning compound material, wherein the cleaning compound on the soft cleaning pad is replenished by at least one of the retraction or extension of the cleaning assembly from the main body.

13. The cleaning apparatus as claimed in claim 11, wherein said replenishment pad is constructed of an absorbent substance.

14. The cleaning apparatus of claim 1, wherein a portion of the replenishment pad and cleaning assembly is covered by a hinged flap that opens for extension and closes upon retraction of said cleaning assembly.

15. A method of using a handheld cleaning apparatus for a display screen, wherein the apparatus comprises a main body, the main body comprising a cavity; a cleaning assembly coupled to the main body, wherein the cleaning assembly comprises a pad having a cleaning compound thereon for wiping upon the surface of a display screen, wherein the cleaning assembly is retractable into the cavity and extendable out of the cavity; and an extending/retracting member, coupled to the cleaning assembly and slideably mounted to the main body, for facilitating the retracting of the cleaning assembly into the cavity and extending the cleaning assembly at least partially out of the cavity, wherein the method comprises the steps of:
grasping the cleaning apparatus in a first hand;
while maintaining a grip on the cleaning apparatus with the first hand, sliding the extending/retracting member with the thumb of the first hand to extend the cleaning assembly from the cavity;
contacting the pad of the cleaning assembly with a display screen;
applying pressure to the pad and wiping the display screen with the pad of the cleaning assembly;
retracting the cleaning assembly into the cavity.

16. The method as claimed in claim 15, the method comprises the automatic replenishment of said pad with said cleaning compound housed in the replenishment pad.
